(19) United States
(12) Patent Application Publication
(10) Pub. No.: US 2026/0203607 A1
(43) Pub. Date: Jul. 16, 2026

(54) SYSTEMS AND METHODS FOR KNOWLEDGE BOUNDARY DETERMINATION

(71) Applicant: Yu Zhang, Beijing (CN)

(72) Inventor: Yu Zhang, Beijing (CN)

(21) Appl. No.: 19/323,795

(22) Filed: Sep. 9, 2025

Related U.S. Application Data
(63) Continuation of application No. PCT/CN2025/072654, filed on Jan. 16, 2025.

(51) Int. Cl. G06N 5/022; G06N 3/042; G06N 3/0475; G06N 3/084

(52) U.S. Cl. CPC G06N 5/022; G06N 3/042; G06N 3/0475; G06N 3/084

(57) ABSTRACT

Disclosed herein are systems, methods, and instrumentalities associated with AI knowledge boundary evaluation. An apparatus may receive a question posted to an AI-based intelligent entity such as a robot. The apparatus may, using a machine learning (ML) model such as a large language model (LLM), extract a first knowledge point from the question and determine a first knowledge hierarchy associated with the first knowledge point. The apparatus may further identify a second knowledge point possessed by the robot that corresponds to the first knowledge point, and determine a second knowledge hierarchy associated with the second knowledge point. By comparing the advancement levels of the first knowledge hierarchy and the second knowledge hierarchy, the apparatus may determine whether the question posted to the robot exceeds the knowledge boundary of the robot.

### CROSS-REFERENCE TO RELATED APPLICATIONS

This application is a continuation of Patent Cooperation Treaty Application No. PCT/CN 2025/072654, filed Jan. 16, 2025, the disclosure of which is incorporated herein by reference in its entirety.

### BACKGROUND

With the development of artificial intelligence (AI) technology, especially the continuous advancement of natural language processing (NLP) technology, AI-based intelligent entities such as conversational robots are becoming increasingly common in our lives. But even though these robots possess general conversation capabilities and/or the ability to answer many types of questions, they still cannot fully conduct human-like conversations that conform to a specific character setting and the limits of the robots'knowledge. In some situations, the robots may even hallucinate and answer questions in a completely nonsensical manner if the robots misunderstand the question or fail to realize that the questions have exceeded the knowledge boundary of the robots. As such, systems, methods, and instrumentalities that can understand a knowledge point inherited in a user question and predict a robot's ability to answer the question based on the understanding may be desirable to make interactions with the robot more vivid, interesting, and resemblant of real life.

### SUMMARY

Disclosed herein are systems, methods, and instrumentalities associated with evaluating the knowledge boundary of an AI-based intelligent entity such as a conversational robot. According to embodiments of the disclosure, an apparatus may be configured to receive a question posted to the robot, extract a first knowledge point from the question and determine a first knowledge hierarchy associated with the first knowledge point. The first knowledge hierarchy may indicate at least a first knowledge category to which the first knowledge point belongs, and the determination may be made using a machine learning (ML) model such as a large language model (LLM). The apparatus may identify, from a plurality of knowledge points possessed by the robot, at least a second knowledge point that corresponds to the first knowledge point, and determine a second knowledge hierarchy associated with the second knowledge point. The second knowledge hierarchy may indicate at least a second knowledge category to which the second knowledge point belongs. By comparing the respective advancement levels of the first knowledge hierarchy and the second knowledge hierarchy, the apparatus may determine whether the question posted to the robot exceeds the knowledge boundary of the robot and may provide a response accordingly.

In some examples, the first knowledge hierarchy described herein may further indicate a first knowledge sub-category to which the first knowledge point belongs, wherein the first knowledge sub-category may be a sub-category of the first knowledge category. Similarly, the second knowledge hierarchy described herein may further indicate a second knowledge sub-category to which the second knowledge point belongs, wherein the second knowledge sub-category may be a sub-category of the second knowledge category. In these examples, the respective advancement levels of the first knowledge hierarchy and the second knowledge hierarchy may be determined based on established labels, standards or special designations that indicate the advancement or difficulty levels of the knowledge categories included in each knowledge hierarchy. These established labels, standards or special designations may be determined based on a knowledge graph (KG) or using a retrieval-augmented generation (RAG) technique. The labels, standards or designations may then be compared to determine the advancement or difficulty levels of the first knowledge hierarchy and the second knowledge hierarchy.

In examples, there may not be established labels, standards or special designations that indicate the advancement or difficulty levels of the knowledge categories included in the first knowledge hierarchy or the second knowledge hierarchy. In these examples, the comparison of the first knowledge hierarchy with the second knowledge hierarchy may be performed using the LLM described above or a separately trained ML model by considering the scopes and/or hierarchical positions of the knowledge categories included in the knowledge hierarchies. For instance, the comparison may be performed by providing a plurality of prompts to the LLM and predicting, using the LLM and based on the plurality of prompts, which of the first knowledge hierarchy or second knowledge hierarchy may be associated with the more advanced knowledge level. Each prompt of the plurality of prompts may indicate a respective logical step for the LLM to follow when determining which of the first knowledge hierarchy or second knowledge hierarchy is associated with the more advanced knowledge level, and the logical steps may constitute (but not limited to) a chain-of-thought (CoT) of the first ML model when executing the task. The plurality of prompts may include a first prompt that instructs the first ML model to consider whether the second knowledge category or the second knowledge sub-category encompasses at least one of the first knowledge category or the first knowledge sub-category. The plurality of prompts may further include a second prompt that instructs the first ML model to consider a hierarchical position of the first knowledge category or the first knowledge sub-category in the first knowledge hierarchy relative to a hierarchical position of the second knowledge category or the second knowledge sub-category in the second knowledge hierarchy.

In examples, the apparatus may be configured to predict the first knowledge category to which the first knowledge point belongs from a set of pre-determined top-level knowledge categories. In examples, the apparatus may be further configured to predict the first knowledge sub-category to which the first knowledge point belongs from a set of pre-determined knowledge sub-categories.

### BRIEF DESCRIPTION OF THE DRAWINGS

A more detailed understanding of the examples disclosed herein may be obtained from the following descriptions, given by way of example in conjunction with the accompanying drawings.

FIG. 1 is a simplified diagram illustrating an example of determining the knowledge boundary of an AI-based intelligent entity such as a conversional robot.

FIG. 2 is a simplified diagram illustrating examples of techniques for determining a knowledge hierarchy associated with a user question and assessing the knowledge boundary of a robot with respect to the user question.

FIG. 3 is a simplified diagram illustrating example techniques for determining the difficulty or advancement levels of two knowledge hierarchies relative to each other.

FIG. 4 is a flow diagram illustrating an example procedure for evaluating whether a question posted to a robot exceeds the knowledge boundary of the robot.

FIG. 5 is a flow diagram illustrating example operations associated with training an artificial neural network to perform one or more of the tasks described herein.

FIG. 6 is a simplified block diagram illustrating an example apparatus that may be configured to perform one or more of the tasks described herein.

### DETAILED DESCRIPTION

The present disclosure is illustrated by way of example, and not by way of limitation, in the accompanying drawings. A detailed description of illustrative embodiments will be provided with reference to these drawings. Although the embodiments may be described with certain details, it should be noted that the details are not intended to limit the scope of the disclosure.

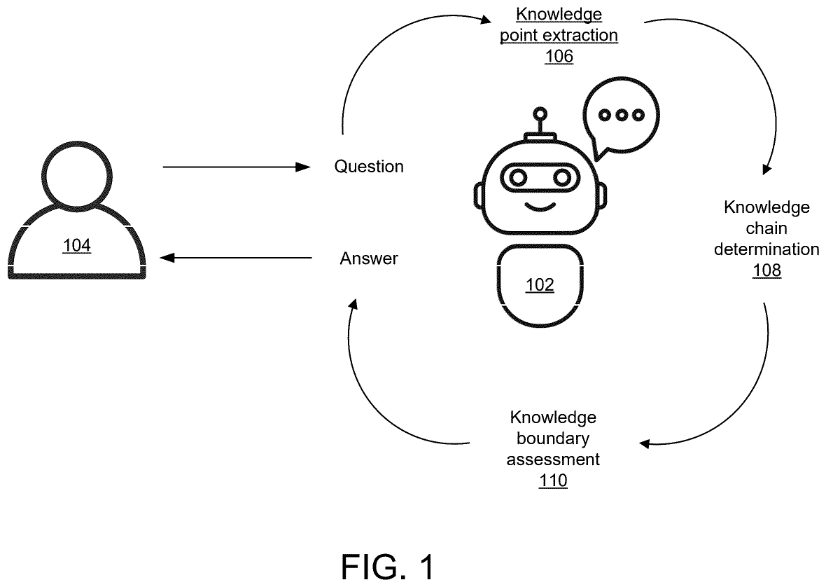

FIG. 1 illustrates an example of a system, method or instrumentality for determining whether a question posted to an AI-based intelligent entity such as a robot exceeds the knowledge boundary of the intelligent entity. Using a conversational robot 102 as an example of the intelligent entity described herein, the question may be posted by a user 104 interacting with the robot 102 and may be in any format including a natural language format such as, for example, “explain how a transformer transfers electric energy.” The robot 102 (e.g., a computing apparatus used to implement the robot, or a computing apparatus configured to act as an agent of the robot) may receive the question and determine (e.g., at 106 of FIG. 1) a knowledge point associated with the question. For example, based on the aforementioned question, the robot 102 may determine that the knowledge point associated with the question is “a transformer.” From the determined knowledge point, the robot 102 may further determine (e.g., at 108 of FIG. 1) a knowledge hierarchy indicative of a hierarchal knowledge structure around the knowledge point. In examples, such a knowledge hierarchy may indicate one or more knowledge categories to which the knowledge point may belong arranged, and may further indicate a hierarchical relationship of the knowledge categories. For instance, the robot 102 may determine that the knowledge point (e.g., “transformer”) extracted from the user question belongs to a top-level knowledge category of “scientific and engineering concepts,” a first-sub-level knowledge category of “electrical and electronic concepts,” and a second-sub-level knowledge category of “passive electrical components.” The robot 102 may arrange these knowledge categories and/or sub-categories into a knowledge hierarchy (e.g., a data structure such as a linked list) that may indicate that the user question is related to “scientific and engineering concepts→electrical and electronic concepts→passive electrical components→transformer.”

Based on the knowledge hierarchy determined at 108, the robot 102 may assess (e.g., at 110 of FIG. 1) whether the question posted by the user (e.g., knowledge point associated with the question) exceeds a knowledge boundary of the robot. The robot 102 may perform the assessment by identifying, from a knowledge base of the robot, a knowledge point that may correspond (e.g., be similar to) to the knowledge point extracted from the user question. The robot 102 may further determine a knowledge hierarchy associated with the corresponding knowledge point and determine (e.g., predict) whether the user question exceeds the knowledge boundary of the robot by comparing the knowledge hierarchy associated with the user question (e.g., a first knowledge hierarchy) with the knowledge hierarchy of the robot (e.g., a second knowledge hierarchy). For example, based on the “transformer” knowledge point extracted from the user question, the robot 102 may determine that it possesses similar knowledge about “a transformer” that belongs to a top-level knowledge category of “scientific and engineering concepts,” a first-sub-level knowledge category of “neural networks and deep learning,” and a second-sub-level knowledge category of “neural network architectures.” The robot 102 may thus determine that the knowledge hierarchy associated with the knowledge point possessed by the robot is “scientific and engineering concepts→neural networks and deep learning→neural network architectures→transformer.” By comparing this knowledge hierarchy with the knowledge hierarchy associated with the user question (e.g., “scientific and engineering concepts→electrical and electronic concepts→passive electrical components→transformer”), the robot 102 may conclude that the user question exceeds the knowledge boundary of the robot because the two knowledge hierarchies diverge after the top knowledge category of “scientific and engineering concepts.” The robot 102 may then provide an answer to the user 104 that may indicate that the robot would not be able to answer the user's question since the question exceeds the knowledge boundary of the robot.

Using the knowledge hierarchy-based techniques illustrated by FIG. 1 and described herein, the robot 102 may more accurately determine the knowledge involved in the user question as well as whether that knowledge falls within the knowledge domain of the robot. For instance, if the robot 102 were to compare only the knowledge point of “transformer” extracted from the user question with the “transformer” knowledge point possessed by the robot, the robot may arrive at a wrong conclusion that it is capable of answering the user's question, even though the “transformer” known by the robot is a neural network architecture and not the electrical “transformer” asked by the user. In contrast, using the knowledge hierarchy-based techniques described herein, the robot 102 may realize that its knowledge about the “transform” belongs to the category of “neural network architectures” and not the category of “passive electrical components” related to the user the question.

It should be noted that even though the example of FIG. 1 refers to the “robot” as the subject that is configured to carry out the various actions described herein, those actions may also be carried out by a separate apparatus configured to facilitate the functions of the robot. For example, the actions described herein may be performed by an apparatus configured as an agent of the robot, which may receive the user's question on behalf of the robot, evaluate the difficulty or advancement level of the question against the knowledge of the robot based on information about the robot possessed by the agent, and provide a response to the user based on the evaluation (e.g., the agent apparatus may decide whether to pass the question to the robot based on its evaluation of whether the robot can answer the question).

It should also be noted that, even though the term “knowledge hierarchy” is used in the description of the techniques disclosed herein, that term should not be interpreted as limiting the implementation of the disclosed techniques to any specific data structure or algorithm. For example, the term “knowledge hierarchy” may be replaced with the term “knowledge hierarchy” or “hierarchical knowledge classification path” without affecting the applicability or validity of the techniques disclosed herein.

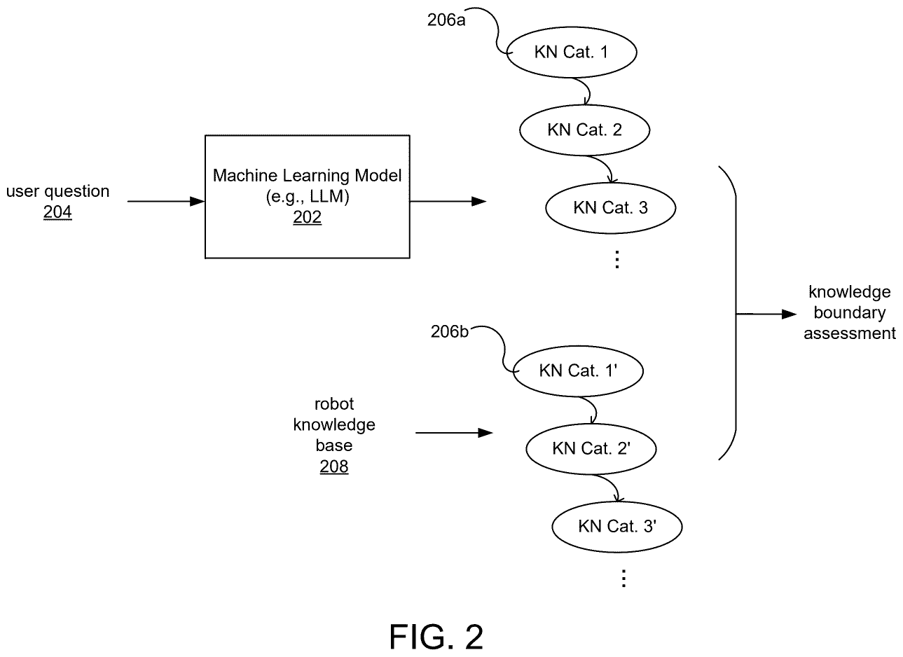

FIG. 2 illustrates examples of techniques for determining a knowledge hierarchy associated with a user question and assessing a knowledge boundary of a robot with respect to the user question. As shown in FIG. 2, the knowledge hierarchy associated with the use question may be determined using a machine learning model such as a large language model (LLM) 202 shown in the figure. The LLM 202 may be designed and trained to understand and/or generate human-like language at a sophisticated level. The model may be trained on vast amounts of diverse textual data and may be capable of performing a wide range of natural language processing (NLP) tasks. For example, through training, the LLM 202 may be able to extract a knowledge point from the user question 204 and determine a knowledge hierarchy 206a associated with the knowledge point. As described above, such a knowledge hierarchy may indicate one or more knowledge categories (e.g., KN Cat. 1, KN Cat. 2 and/or KN Cat. 3 shown in FIG. 2) to which the extracted knowledge points may belong and/or a hierarchical relationship of the knowledge categories (e.g., KN Cat. 1 may be a top knowledge category, KN Cat. 2 may be a sub-category of KN Cat. 1, and/or KN Cat. 3 may be a sub-category of KN Cat. 2).

The LLM 202 may be trained using various techniques to acquire the ability to generate the knowledge hierarchy 206a for the user question 204. These training techniques may include, for example, few-shot training techniques via which the LLM may learn to perform the task based on a number of examples and adapt the learned skills to a wider range of scenarios. For example, during the training of the LLM, a question formatted in natural language may be provided to the LLM to cause the LLM to predict a knowledge hierarchy associated with the question. The prediction made by the LLM may then be compared to a ground-truth knowledge hierarchy to determine a loss associated with the prediction (e.g., using various suitable loss functions). The loss (e.g., a gradient descent of the loss) may be backpropagated through the LLM to adjust the parameters (e.g., neural network kernel weights) of the LLM such that the loss may be reduced or minimized.

In examples, prompt engineering may be used to guide the training of the LLM 202. For example, the question posted to the LLM may be crafted to provide contexts to the question and/or instruct the LLM to generate responses in a specific way. The prompt(s) may also provide examples that demonstrate what result the LLM is expected to produce and/or ways to derive the result. The prompt(s) may also be crafted to control the granularity of sub-nodes at different levels of the predicted knowledge hierarchy (e.g., from the top node to the current knowledge point).

In examples, the LLM 202 may be forced to predict one or more top-level (e.g., the first two levels) knowledge categories of the knowledge hierarchy 206a from respective sets of predetermined knowledge categories. These predetermined knowledge categories may be derived from an existing human knowledge classification system. For instance, the LLM 202 may be restricted to predicting the top knowledge category of the knowledge hierarchy 206a from a set of five pre-determined top knowledge categories consisting of “science and engineering concepts,” “humanity concepts,” “financial concepts,” “arts,” and “health and medicine.” This way, when deployed after the training, the LLM 202 may be able to lock up one or more top nodes or levels of the predicted knowledge hierarchy (e.g., a top node and a direct child node of the knowledge hierarchy) so that the prediction may remain relatively stable even if a diverse set of questions is received at the input.

The LLM 202 may have a large number of parameters (e.g., hundreds of billions of parameters) and may employ a transformer architecture having an attention mechanism that allows the LLM to focus on different parts of an input sequence (e.g., represented by tokens) derived from the user question 204 when making predictions about the knowledge point inherited in the user question or about the knowledge hierarchy 206a. The transformer architecture may include one or more embedding layers configured to convert discrete tokens, such as words or sub-words, into vector representations. These vector representations (which may also be referred to as embeddings) may capture the semantic meaning of the tokens and serve as the input to the transformer architecture (e.g., the embedding layer(s) may map each token to a fixed-length vector in a continuous vector space, enabling the LLM to work with and process textual data). The vector representations may capture semantic information about the tokens, which may be crucial for the self-attention mechanism and other operations within the transformer layers. As the LLM is trained, the parameters of the LLM may be updated through backpropagation, allowing the model to learn meaningful representations of the input tokens based on the data it is exposed to.

The self-attention mechanism may enable the LLM 202 to weigh the importance of different parts of an input sequence (e.g., derived from the user question 204) when making predictions about the knowledge point inherited in the user question 204 or about the knowledge hierarchy 206a. The self-attention mechanism may include three sets of learnable vectors for each element in the sequence: Query (Q), Key (K), and Value (V) vectors. These vectors may be generated from the input sequence through learned linear transformations. For each element, a query vector may be generated, along with corresponding key and value vectors. The self-attention mechanism may calculate a weighted sum of the value vectors for each element based on the similarity between the query vector of that element and the key vectors of one or more other elements. The similarity may be computed using dot products, which may be then scaled and passed through a softmax function to obtain a set of attention weights. The attention weights may determine how much each element contributes to the output, and the output for each element may be computed as a weighted sum of the value vectors, with the weights determined by the attention mechanism (e.g., the output may represent a weighted combination of the information from other elements in the sequence).

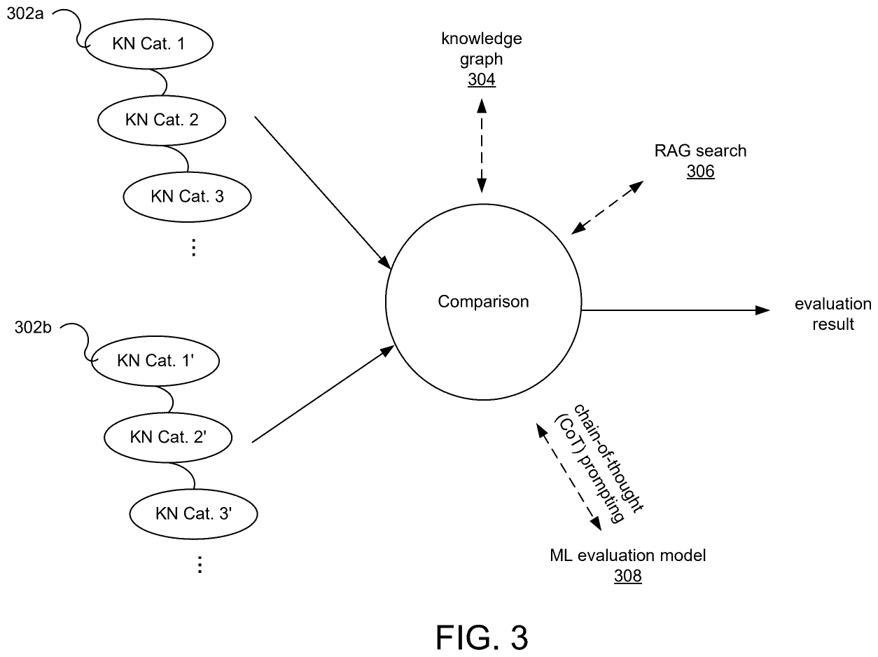

To assess whether the knowledge point associated with the user question 204 exceeds the knowledge boundary of the robot, a knowledge hierarchy 206b associated with a corresponding knowledge point of the robot may be determined and compared to the knowledge hierarchy 206a associated with the user question. In examples, the knowledge hierarchy 206b may be determined based on a knowledge base 208 of the robot, which may be on pre-cataloged and recorded (e.g., a database may be used to record the knowledge points of the robot and the respective knowledge hierarchies associated with those knowledge points). In examples, the knowledge hierarchy 206b for the robot may also be determined using the LLM 202, for example, in similar manners as those described for determining the knowledge hierarchy 206a associated with the user question. Once derived, the knowledge hierarchy 206b may be compared with the knowledge hierarchy 206a to evaluate whether the user question 204 exceeds the knowledge boundary of the robot. Greater details about the techniques that may be used to compare the two knowledge hierarchies will be provided with reference to FIG. 3.

FIG. 3 illustrates example techniques for determining the difficulty or advancement levels of two knowledge hierarchies in comparison to each other. The knowledge hierarchies (e.g., 302a and 302b of FIG. 3) may be obtained using the techniques described herein (e.g., predicted using LLM 202 of FIG. 2), and may each include one or more knowledge categories arranged in a hierarchical order. In some situations, these knowledge categories may have established labels, standards, gauges or special designations that indicate the advancement or difficulty levels of the knowledge categories included in each knowledge hierarchy. In these situations, the relative advancement levels of the knowledge hierarchies 302a, 302b may be determined by comparing the established labels, standards, gauges or designations for the knowledge categories. The labels, standards, gauges or designations may be determined using various techniques including, for example, by consulting a knowledge graph (KG), as shown by 304 of FIG. 3, or by performing a retrieval-augmented generation (RAG), as shown by 306 of FIG. 3.

The knowledge graph based approach may involve designing and building a structured representation of knowledge categories, their attributes (e.g., advancement levels), and the relationships between the knowledge categories. The data needed to construct such a representation may be obtained from various databases, application programming interfaces (APIs), text documents, websites, research papers, or social media. The construction may involve data preprocessing, such as removing duplicates, fixing errors, and standardizing formats. The construction may also involve identifying relevant entities from the collected data, resolving ambiguities, and creating a schema that includes high-level concepts (e.g., categories or classes), specific entities within those concepts, as well as properties and/or relationships of the entities. In some examples, natural language processing techniques may be used to automatically extract the entities and/or their relationships from the collected data, while in other examples human experts may also be deployed to validate and/or add to the entities and relationships. The representation may be constructed as a graph, with nodes representing the entities and edges representing the relationships. The constructed graph may be stored and/or managed using a database, which may be queried using a suitable language. The knowledge graph may also be enriched by linking it to external data sources such as external databases or wiki websites.

The RAG based approach may generate informed and contextually accurate responses to an inquiry about the advancement level of a knowledge hierarchy by retrieving relevant information from a data source (e.g., an external data source) and integrating it with a generative process for producing a response. The main components of the RAG approach may include a retriever and a generator. The retriever may be responsible for retrieving relevant information from the data source (e.g., a document repository or a custom database), while the generator may be responsible for generating the response (e.g., using a pre-trained transformer-based language model) based on the retrieved information and the input query. In addition to finding the most relevant information for the input query, the retriever may also combine the retrieved information with the input query to form an augmented context, which may be used to ascertain the relative advancement levels of the knowledge hierarchies 302a, 302b when the retrieved information alone cannot clearly differentiate them (e.g., when the retrieved information indicates that the knowledge hierarchies are at the same advancement level).

In some situation, there may not be established or dedicated labels or gauges that indicate the advancement levels of the knowledge categories in the knowledge hierarchy 302a or 302b. In those situations, the comparison of the knowledge hierarchies may be accomplished using a machine learning model pretrained for evaluating the advancement levels of the knowledge categories based on their hierarchical structures, as shown by 308 of FIG. 3. The machine learning model may be the LLM 202 shown in FIG. 2 or a separately trained model dedicated for the evaluation task. In either case, the model may be trained to predict the relative difficulty or advancement levels of the knowledge hierarchies based on the positions, scopes and other attributes of the knowledge categories included the knowledge hierarchies. For example, the model may be trained to consider one or more of the following pieces of information when evaluating the relative advanced level of the knowledge hierarchies 302a, 302b (e.g., assuming 302a represents a user question and 302b represents the knowledge of a robot): whether the knowledge category associated with a knowledge point in knowledge hierarchy 302a is encompassed in the knowledge category associated with a corresponding knowledge point in knowledge hierarchy 302b (e.g., the two knowledge categories may be regarded as the same if one encompasses the other), whether the knowledge point in knowledge hierarchy 302a belongs to a sub-category of the knowledge point in knowledge hierarchy 302b (e.g., the two categories have a parent-child relationship), whether the knowledge category associated with the knowledge point in knowledge hierarchy 302a is positioned higher in the knowledge hierarchy than the knowledge category associated with the knowledge point in knowledge hierarchy 302b (e.g., hierarchical orders of the knowledge categories), or the complexity of the knowledge point in knowledge hierarchy 302a compared to that of the knowledge point in knowledge hierarchy 302b (e.g., the relative complexity of the two knowledge points).

These characteristics may be considered as multi-dimension features (e.g., quantified into corresponding feature vectors) that may be extracted from the knowledge hierarchies 302a, 302b and used to predict the relative advancement level of the knowledge hierarchies. In the case of using a separate evaluation or classification model for the prediction, the model may be trained to extract these features, make a prediction about the relative advancement level of the knowledge hierarchies, and adjust the model parameters by comparing the prediction with an annotated result serving as the ground truth for the prediction (e.g., the comparison may be made based on a loss function).

In the case of using an LLM (e.g., the LLM 202 shown in FIG. 2) for the prediction, the LLM may be trained to apply chain-of-thought (CoT) logic when making the prediction, or the LLM may be prompted to follow certain CoT logic when making the prediction. In either case, each step of the CoT logic may correspond to a relatively simple proposition or logical step for the LLM to consider or follow, such as, for example, determining whether one knowledge category encompasses another, whether one knowledge category belongs to another knowledge category, whether one knowledge category is positioned higher in a knowledge hierarchy than another knowledge category, etc. In the case of using prompt engineering to guide the LLM to apply such CoT logic, the aforementioned propositions or logical steps may be indicated to the LLM via one or more prompts, each of which may correspond to a respective one of the propositions or logical steps.

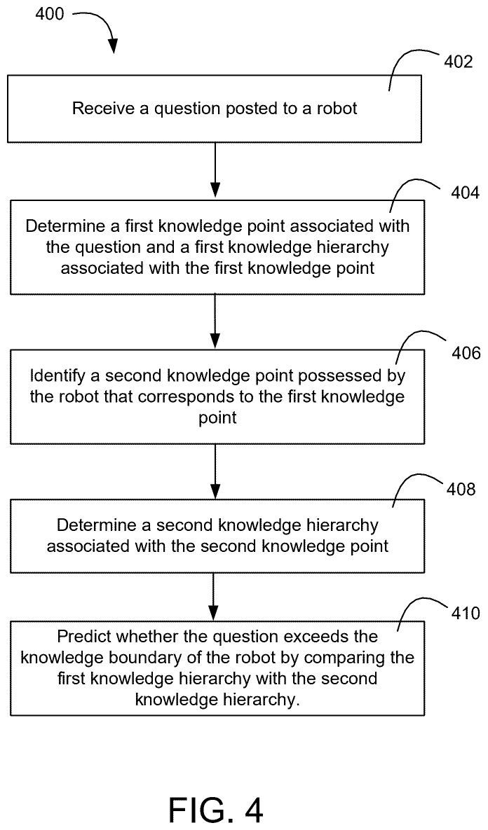

FIG. 4 illustrates an example procedure 400 for evaluating whether a question posted to an AI-based intelligent entity such a conversational robot exceeds the knowledge boundary the robot. As shown in FIG. 4, the procedure 400 may include receiving the question posted to the robot at 402, and determining, at 404, a first knowledge point associated with the question and a first knowledge hierarchy associated with the first knowledge point. The first knowledge hierarchy may indicate at least a first knowledge category to which the first knowledge point belongs, and the determination may be made using a machine learning model such as an LLM (e.g., the LLM in FIG. 2). Also as shown in FIG. 4, the procedure 400 may further include identifying, at 406, a second knowledge point from a knowledge base of the robot that may correspond to the first knowledge point, and determining, at 408, a second knowledge hierarchy that may be associated with the second knowledge point. Such a second knowledge hierarchy may indicate at least a second knowledge category to which the second knowledge point belongs, and the procedure 400 may additionally include predicting whether the question posted to the robot exceeds the knowledge boundary of the robot by comparing the first knowledge hierarchy with the second knowledge hierarchy.

In some examples, the first knowledge hierarchy described herein may further indicate a first knowledge sub-category to which the first knowledge point may belong, wherein the first knowledge sub-category may be a sub-category of the first knowledge category. Similarly, the second knowledge hierarchy described herein may further indicate a second knowledge sub-category to which the second knowledge point may belong, wherein the second knowledge sub-category may be a sub-category of the second knowledge category. In at least these examples, the comparison of the first knowledge hierarchy with the second knowledge hierarchy may be performed using a machine learning model (e.g., the same LLM described above or a separate machine learning model) that may be trained to evaluate the relative advancement level of the two knowledge hierarchies by considering the hierarchical positions and/or scopes of the knowledge categories included in the knowledge hierarchies.

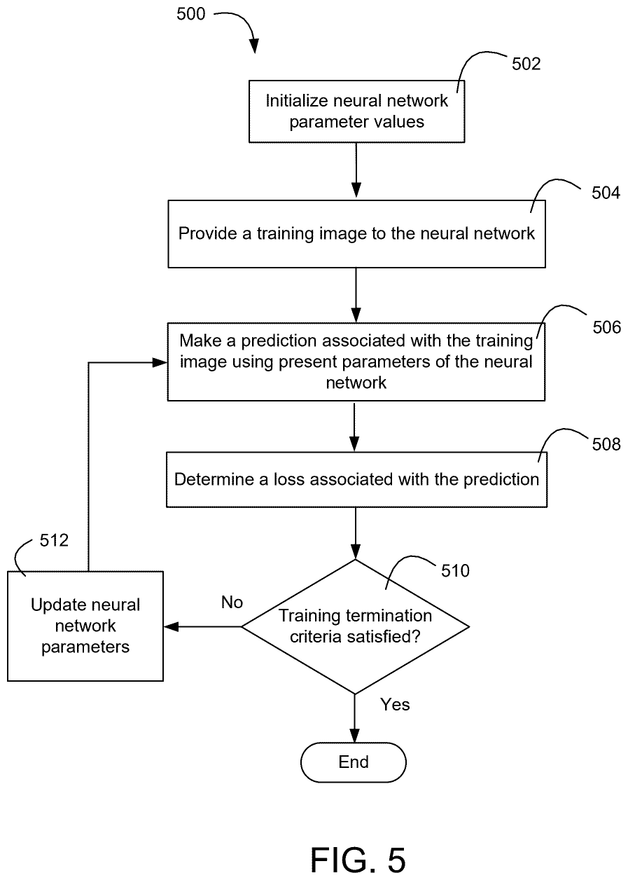

FIG. 5 illustrates example operations 500 that may be associated with training an artificial neural network (e.g., which may be configured to implement one or more of the ML models described herein) to perform one or more of the tasks described herein. As shown in FIG. 5, the training operations 500 may include initializing the operating parameters of the neural network (e.g., weights associated with various layers of the neural network) at 502, for example, by sampling from a probability distribution or by copying the parameters of another neural network having a similar structure. The training operations may further include providing an input (e.g., a user question) to the neural network at 504 and causing the neural network to make a prediction (e.g., about a knowledge hierarchy associated with the user question) using presently assigned network parameters at 506. At 508, the training operations may include determining a loss associated with the prediction, for example, based on a difference between the prediction and corresponding ground truth. At 510, the training operations may further include determining whether one or more training termination criteria have been satisfied. For example, the training termination criteria may be determined to have been satisfied if the difference between the prediction and the ground truth falls below a predetermined threshold value. If the determination at 510 is that the training termination criteria are satisfied, the training may end. Otherwise, the presently assigned network parameters may be adjusted at 512, for example, by backpropagating a gradient descent of the loss through the network, before the training returns to 506.

For simplicity of explanation, the training operations are depicted and described herein with a specific order. It should be appreciated, however, that the training operations may occur in various orders, concurrently, and/or with other operations not presented or described herein. Furthermore, it should be noted that not all operations that may be included in the training process are depicted and described herein, and not all illustrated operations are required to be performed.

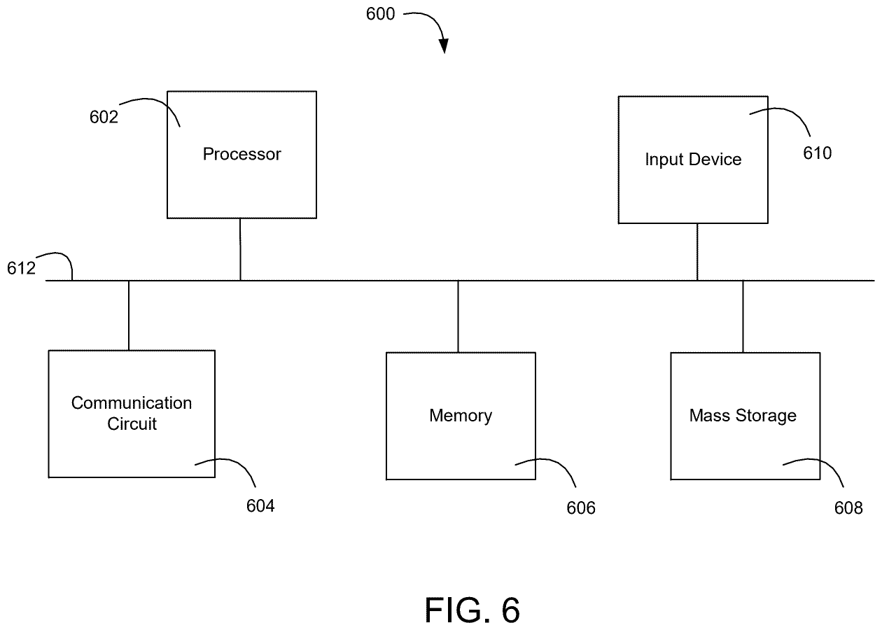

The systems, methods, and/or instrumentalities described herein may be implemented using one or more processors, one or more storage devices, and/or other suitable accessory devices such as display devices, communication devices, input/output devices, etc. FIG. 6 is a block diagram illustrating an example apparatus 600 that may be configured to perform the tasks described herein. As shown, apparatus 600 may include a processor (e.g., one or more processors) 602, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 600 may further include a communication circuit 604, a memory 606, a mass storage device 608, an input device 610, and/or a communication link 612 (e.g., a communication bus) over which the one or more components shown in the figure may exchange information.

The communication circuit 604 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). The memory 606 may include a storage medium (e.g., a non-transitory storage medium) configured to store machine-readable instructions that, when executed, cause the processor 602 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. The mass storage device 608 may include one or more magnetic disks such as one or more internal hard disks, one or more removable disks, one or more magneto-optical disks, one or more CD-ROM or DVD-ROM disks, etc., on which instructions and/or data may be stored to facilitate the operation of the processor 602. The input device 610 may include a keyboard, a mouse, a voice-controlled input device, a touch sensitive input device (e.g., a touch screen), and/or the like for receiving user inputs to apparatus 600.

It should be noted that apparatus 600 may operate as a standalone device or may be connected (e.g., networked, or clustered) with other computation devices to perform the functions described herein. And even though only one instance of each component is shown in FIG. 6, a skilled person in the art will understand that apparatus 600 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should therefore be determined with reference to the appended claims, along with the full scope of equivalents to which such claims are entitled.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

1. A method for determining a knowledge boundary of a robot, comprising:
receiving a question;
determining, using a first machine learning (ML) model, a first knowledge point associated with the question and a first knowledge hierarchy associated with the first knowledge point, the first knowledge hierarchy indicating at least a first knowledge category to which the first knowledge point belongs;
identifying, from a plurality of knowledge points possessed by the robot, at least a second knowledge point that corresponds to the first knowledge point;
determining a second knowledge hierarchy associated with the second knowledge point, the second knowledge hierarchy indicating at least a second knowledge category to which the second knowledge point belongs; and
predicting whether the question exceeds the knowledge boundary of the robot by comparing the first knowledge hierarchy with the second knowledge hierarchy.

2. The method of claim 1, wherein the first knowledge hierarchy further indicates a first knowledge sub-category to which the first knowledge point belongs, the first knowledge sub-category being a sub-category of the first knowledge category.

3. The method of claim 2, wherein the second knowledge hierarchy further indicates a second knowledge sub-category to which the second knowledge point belongs, the second knowledge sub-category being a sub-category of the second knowledge category.

4. The method of claim 3, wherein comparing the first knowledge hierarchy with the second knowledge hierarchy comprises:
providing a plurality of prompts to the first ML model, wherein each prompt indicates a respective logical step for the first ML model to follow when determining which of the first knowledge hierarchy or second knowledge hierarchy is associated with a more advanced knowledge level; and
predicting, using the first ML model and based on the plurality of prompts, which of the first knowledge hierarchy or the second knowledge hierarchy is associated with the more advanced knowledge level.

5. The method of claim 4, wherein the plurality of prompts includes a first prompt that instructs the first ML model to consider whether the second knowledge category or the second knowledge sub-category encompasses at least one of the first knowledge category or the first knowledge sub-category.

6. The method of claim 5, wherein the plurality of prompts further includes a second prompt that instructs the first ML model to consider a hierarchical position of the first knowledge category or the first knowledge sub-category in the first knowledge hierarchy relative to a hierarchical position of the second knowledge category or the second knowledge sub-category in the second knowledge hierarchy.

7. The method of claim 4, wherein the logical steps followed by the first ML model when determining which of the first knowledge hierarchy or second knowledge hierarchy is associated with the more advanced knowledge level constitute a chain-of-thought (CoT) of the first ML model.

8. The method of claim 3, wherein comparing the first knowledge hierarchy with the second knowledge hierarchy comprises predicting, using a second ML model, which of the first knowledge hierarchy or the second knowledge hierarchy is associated with a more advanced knowledge level.

9. The method of claim 2, wherein the first ML model is configured to predict the first knowledge sub-category to which the first knowledge point belongs from a set of pre-determined knowledge sub-categories.

10. The method of claim 1, wherein the first ML model is configured to predict the first knowledge category to which the first knowledge point belongs from a set of pre-determined top-level knowledge categories.

11. The method of claim 1, wherein comparing the first knowledge hierarchy with the second knowledge hierarchy comprises:
determining, based on a knowledge graph (KG) or a retrieval-augmented generation (RAG), a first advancement level of the first knowledge category and a second advancement level of the second knowledge category; and
comparing the first advancement level with the second advancement level.

12. The method of claim 11, wherein the prediction is that the question exceeds the knowledge boundary of the robot if the first advancement level is determined to be higher than the second advancement level.

13. An apparatus, comprising:
one or more processors configured to
receive a question;
determine, using a first machine learning (ML) model, a first knowledge point associated with the question and a first knowledge hierarchy associated with the first knowledge point, the first knowledge hierarchy indicating at least a first knowledge category to which the first knowledge point belongs;
identify, from a plurality of knowledge points possessed by the robot, at least a second knowledge point that corresponds to the first knowledge point;
determine a second knowledge hierarchy associated with the second knowledge point, the second knowledge hierarchy indicating at least a second knowledge category to which the second knowledge point belongs; and
predict whether the question exceeds a knowledge boundary of the robot by comparing the first knowledge hierarchy with the second knowledge hierarchy.

14. The apparatus of claim 13, wherein the first knowledge hierarchy further indicates a first knowledge sub-category to which the first knowledge point belongs, the first knowledge sub-category being a sub-category of the first knowledge category.

15. The apparatus of claim 14, wherein the second knowledge hierarchy further indicates a second knowledge sub-category to which the second knowledge point belongs, the second knowledge sub-category being a sub-category of the second knowledge category.

16. The apparatus of claim 15, wherein the one or more processors being configured to compare the first knowledge hierarchy with the second knowledge hierarchy comprises the one or more processors being configured to:
provide a plurality of prompts to the first ML model, wherein each prompt indicates a respective logical step for the first ML model to follow when determining which of the first knowledge hierarchy or the second knowledge hierarchy is associated with a more advanced knowledge level; and
predict, using the first ML model and based on the plurality of prompts, which of the first knowledge hierarchy or the second knowledge hierarchy is associated with the more advanced knowledge level.

17. The apparatus of claim 16, wherein the logical steps followed by the first ML model when determining which of the first knowledge hierarchy or second knowledge hierarchy is associated with the more advanced knowledge level constitute a chain-of-thought (CoT) of the first ML model.

18. The apparatus of claim 16, wherein the plurality of prompts includes a first prompt that instructs the first ML model to consider whether the second knowledge category or the second knowledge sub-category encompasses at least one of the first knowledge category or the first knowledge sub-category, and wherein the plurality of prompts further includes a second prompt that instructs the first ML model to consider a hierarchical position of the first knowledge category or the first knowledge sub-category in the first knowledge hierarchy relative to a hierarchical position of the second knowledge category or the second knowledge sub-category in the second knowledge hierarchy.

19. The apparatus of claim 15, wherein the one or more processors being configured to compare the first knowledge hierarchy with the second knowledge hierarchy comprises the one or more processors being configured to predict, using a second ML model, which of the first knowledge hierarchy or the second knowledge hierarchy is associated with a more advanced knowledge level.

20. The apparatus of claim 13, wherein the first ML model is configured to predict the first knowledge category to which the first knowledge point belongs from a set of pre-determined top-level knowledge categories.

21. The apparatus of claim 13, wherein the one or more processors being configured to compare the first knowledge hierarchy with the second knowledge hierarchy comprises the one or more processors being configured to:
determine, based on a knowledge graph (KG) or a retrieval-augmented generation (RAG), a first advancement level of the first knowledge category and a second advancement level of the second knowledge category; and
compare the first advancement level with the second advancement level.

22. A non-transitory computer-readable medium comprising instructions that, when executed by a processor included in a computing device, cause the processor to implement the method of claim 1.
